(19) United States
(12) Patent Application Publication
(10) Pub. No.: US 2002/0048307 A1
(43) Pub. Date: Apr. 25, 2002

(54) Device and process for infrared temperature measurement

(76) Inventor: Volker Schmidt, Berlin (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/916,162

(22) Filed: Jul. 25, 2001

Related U.S. Application Data
(60) Provisional application No. 60/232,601, filed on Sep. 14, 2000.

(51) Int. Cl. G01J 5/02; G01K 1/00; G01B 11/00

(52) U.S. Cl. 374/121; 374/141; 362/35; 362/259; 356/49; 356/399; 374/120; 250/491.1

(57) ABSTRACT

A device for the non-contact temperature measurement on an object comprises a detector device with a detector and IR optics, which image the detector along a measuring beam path with an optical axis onto a measuring spot on the object, and a sighting device for the visualization of the measuring spot with a light source for the creation of marking light and ring optics, which form a marking beam path that surrounds the outer circumference of the measuring beam path. The marking light is aligned so that on each location of the marking beam path its cross section, vertical to the optical axis, forms a circular ring surface.

### CROSS-REFERENCES TO RELATED APPLICATIONS

This application is a continuation of and claims the benefit of U.S. Provisional Application No. 60/232,601, filed Sep. 14, 2000, and also claims priority from German Application No. ______, filed ______. The disclosures of each of those applications are incorporated herein by reference.

### BACKGROUND OF THE INVENTION

The invention concerns a device for the non-contact temperature measurement of objects such as, for example, an IR temperature measurement instrument which is equipped with a detector and a sighting system for the visualization of the measurement spot of the detector on the object, and a process for the creation of a visually recognizable marking of the measurement spot of IR temperature measurement instruments.

IR temperature measurement instruments serve to measure, with an IR detector and without contact, the temperature of the object through detection of the infrared (IR) radiation emitted by the object. The area of the object whose radiation is measured by the detector is described as the (radiation) measurement spot of the temperature-measurement instrument. For a precise temperature measurement it is important to know the location and size of the measurement spot. These characteristics are generally dependent on the field of view of the detector and especially on the alignment of the measurement instrument as well as the structure of the detector, the characteristics of the IR optics and on the measuring distance. There are many different well-known designs of sighting systems for measurement spot visualization, which are all based on the creation of a visible marking inside or at the edge of the measuring spot.

The marking comprises, for example, several light points (e.g. DE-OS 3213955, JP 62-12848, U.S. Pat. No. 5,368,392, DE-OS 196 54 276), which are created with light sources (e.g. lasers) and adapted imaging optics at the edge of the measurement field. The creation of light points has the disadvantage that the imaging optics, possibly with beam splitters, are relatively complex to adjust. Furthermore, experiences in practice have shown that the operator of the instrument may have some uncertainty as to whether several measuring spots are marked with the light points and what shape the measuring spot really has.

In principle the possibility exists to increase the number of light points used for marking, so that the measuring spot is surrounded by a dotted line. The density of the light points is, however, limited for design reasons. The imaging optics or beam splitters cannot be made arbitrarily smaller. For example, according to DE-OS 196 54 276, the light points are created with laser beams running towards each other askew and which are redirected with a deviating prism to the desired direction. The deviating prisms must be larger than the diameter of the laser beams to avoid discontinuous transitions, light losses and false beams. The same also applies to the separation distances of the deviating prisms. The light points on the measuring spot thus typically obtain separation distances in the centimeter range.

It is also known how to visualize the measuring spot with a mark, which is perceptible as a continuous surrounding line or as illumination of the measuring spot. For example, a continuous boundary is perceived if a laser beam is guided by a rapidly rotating mirror around the measuring spot (e.g. EP 0 867 699 A2). Movable mechanical component parts are, however, undesirable because of their energy consumption and increased susceptibility to breakdown, especially in portable IR temperature measurement equipment.

A sighting system is known from U.S. Pat. No. 4,494,881, in which the measuring beam path is illuminated down to the measuring spot with a cone of visible light. This instrument also has adjustment problems since the aperture angle of the light cone must be adjusted as precisely as possible to the aperture angle of the detector. In addition, when used in practice, user uncertainties arise again as to whether the illumination of the measurement field with visible light possibly falsifies the temperature measurement result.

An IR temperature measurement instrument is known from EP 0 458 200 A2 (as well as U.S. Pat. No. 5,172,978) in which the sighting system is arranged coaxially around a combination of a detector and a condenser lens. With the condenser lens, the detector is image-focused onto the object. The measuring spot has only the size of the sensor surface of the detector. The sighting system is formed by at least one ring lens, with which an additional light source is also image-focused onto the object. This IR temperature-measuring instrument has the following disadvantages. It is limited to temperature measurements with short object distances (close focus). Since the ring lens is an outer ring cutout of a convex lens, the light from the light source can only be imaged on the optical axis of the detector just like with a convex lens. If the object is located in front of or behind the focus, the marking widens out to extensive lighting. An imaging of the light source over greater object distances (above a few dozen cm) is impossible.

### BRIEF SUMMARY OF THE INVENTION

It is the purpose of the invention to present an improved device for non-contact temperature measurement, with which the disadvantages of the conventional IR measurement instruments are avoided and which especially permits a well-noticeable measuring spot visualization with high accuracy and reproducibility, which has a broader application area and is easy to adjust. It is also the purpose of the invention to show an improved process for measuring spot visualization.

These tasks are solved with a device and a process with the characteristics according to Patent claims 1 through 10. Advantageous design forms and uses of the invention will be shown in the claims attached.

The basic idea of the invention consists of a device for non-contact temperature measurement, which images a detection device with a detector and IR optics, which image the detector along a measuring beam path with an optical axis onto a measuring spot on the object, and has a sighting system for the visualization of the measuring spot with a light source to create marking light and a ring optic, which forms a marking beam path, that surrounds the outer circumference of the measuring beam path, and to continue shaping it with the effect that the marking light is aligned so that at each location of the marking beam path its vertical diameter relative to the optical axis forms a circular ring surface.

The ring optics according to the invention have the advantage that with one single optical design element, at each distance between the measurement device and the object a ring-shaped measuring spot mark is produced. In another form, the light field for measuring spot visualization forms a circular ring at each location of the marking beam path with constant radial width and possibly distance-dependent diameter. The optical structural element is easy to adjust and can be laid out in different type models/design forms for all operating types of an IR measurement device of interest, especially for a temperature measurement with optics that image finitely or infinitely. The width of the circular ring may be as small as typical light point diameters in conventional sighting system designs (e.g. 1 mm), so that the marking is perceived as a sharp circular line independent of the measuring distance.

According to one model of the invention the imaging optics of the sighting system contains at least one ring lens, whose body, at least in sections, has the shape of a toroid surface. Along the entire circumference the body of the ring lens has one axial cross section surface each, which on the side of the imaging optic pointing to the object has the shape of a semicircle or a sector of a circle. This ring lens is described here as toroid lens.

According to an initial design form, the toroid lens produces a cylindrical or cone-shaped beam path. This design form is intended for a detector with optics that image into the infinite. The body of the toroid lens is arranged around the optical axis of the detector radial-symmetrically, the vertical line of the toroid form lying in a reference plane that stands vertically on the optical axis.

According to a second design form, the toroid lens produces a marking beam path in the shape of a straight, one sheet hyperboloid, which in finite distance from the measurement device has a constriction or waist. This design form is laid out for a detector with optics imaging to the finite. The waist of the marker beam path has a distance from the measuring device corresponding to the position of the measuring spot on which the detector is focused. For this, the body of the toroid lens has a toroid form surface in sections, whose vertical line in at least two partial sections lies in reference planes, which form an angle unequal to 90° opposite the optical axis of the detector. On the side pointing to the object, the toroid lens has a surface in the form of a partly continuous toroid surface with a helical gradient. In this design form the marking light in the marking beam path runs at an obtuse angle to the optical axis of the detector.

According to a second type model of the invention the imaging optics of the sighting system contains at least one ring lens, whose body has on the side pointing to the object a multitude of radially aligned prismatic bevels. In this design form, the marking light in the marking beam path also runs at an obtuse angle to the optical axis of the detector. This ring lens is called a bevel-edged lens here. The bevels may possess a curved surface, so that the above-named second design form of the toroid lens results.

A specific advantage of the invention is that with the sighting system according to the invention with the toroid- or the bevel-edged lens a coaxial light bundle is created, which always widens out along the outer rim of the measuring beam path of the detector. At any arbitrary distance and on each arbitrary projection plane, the form of the measuring spot is shown with a clearly visible, circular ring form line. The marking beam path does not have a focus.

Other advantages and details of the invention are described in the following with reference to the enclosed drawings. The following show:

### BRIEF DESCRIPTION OF THE DRAWINGS

FIG. 1 is a schematic general representation of a device according to the invention for non-contact temperature measurement;

FIG. 2 is a schematic illustration of the measuring and marking beam paths in the first design form of the measuring device according to the invention (first design form);

FIG. 3 is a sectional representation of the toroid lens;

FIG. 4 is a schematic illustration of the measuring and marking beam paths in the first type model of the measurement device according to the invention (second design form);

FIG. 5 is an enlarged representation of the toroid lens, as is provided for the type model according to FIG. 4;

FIG. 6 is a schematic illustration of the measuring and marking beam paths in the second type model of the measurement device according to the invention;

FIG. 7 is an enlarged representation of the bevel-edged lens, as is provided for the type model according to FIG. 6;

FIG. 8 is a schematic representation of the circular ring surface of the marking light according to a first variant; and

FIG. 9 is a schematic representation of the circular ring surface of the marking light according to a second variant.

### DETAILED DESCRIPTION OF THE INVENTION

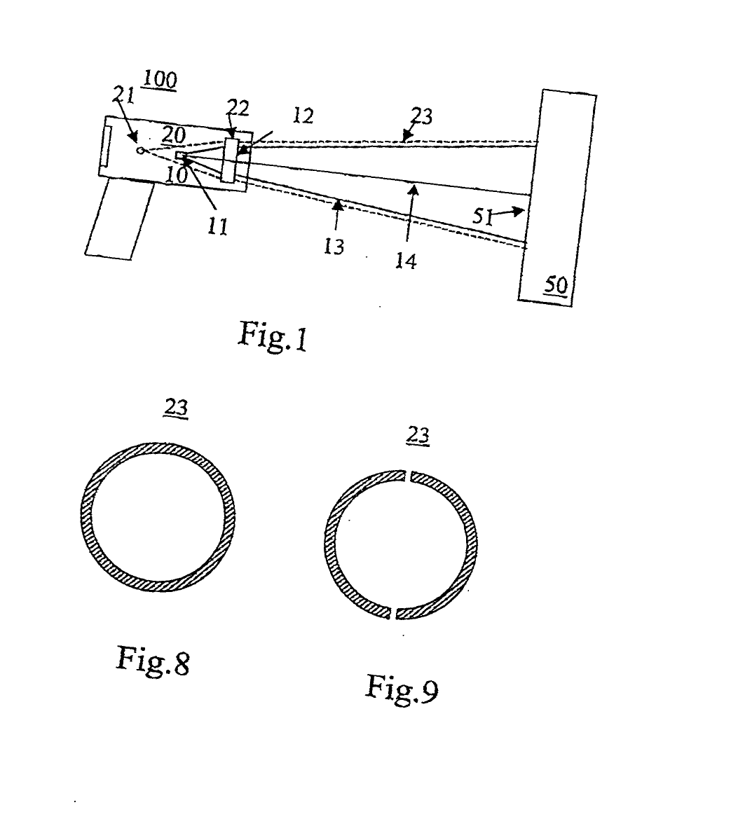

FIG. 1 illustrates in schematic overview representation a device according to the invention for non-contact temperature measurement (IR measuring instrument 100) on an object 50. The set-up of IR measuring instruments is known as such and is explained here merely in reference to the detector and sighting systems. All other parts, especially the guidance and interpretation electronics, operating and warning installations and the housing may be set up as is known from conventional IR measuring instruments. The invention is not limited to a specific instrument type and can be realized especially with portable, hand-held or locally mounted measuring instruments.

The IR measuring instrument 100 contains a detector setup 10 and a sighting system 20. The detector setup 10 includes a detector 11 and IR optics 12, with which the detector 11 is imaged along the measuring beam path 13 onto object 50. The measuring beam path 13 is radial-symmetrical to optical axis 14. In the type model example shown, detection takes place with optics imaging into the infinite, i.e. the measuring beam path 13 widens out cone-shape with increasing distance from the IR measuring instrument 100. The measuring spot 51 is formed where the measuring beam path 11 falls on the object 50. The detector is designed to register the IR radiation from measuring spot 51.

With the sighting system 20, along the marking beam path 23, visible light is aimed at the object to mark the measuring spot 51. The sighting system 20 comprises a light source 21 for the creation of the marking light and ring optics 22, whose details are described below. The light source 21 is preferably a laser source, e.g. a laser diode, but may also be formed by other lamps or lighting elements (e.g. the end of a light pipe or fiber). The measuring and marking beam paths 13, 23 have the same optical axis 14.

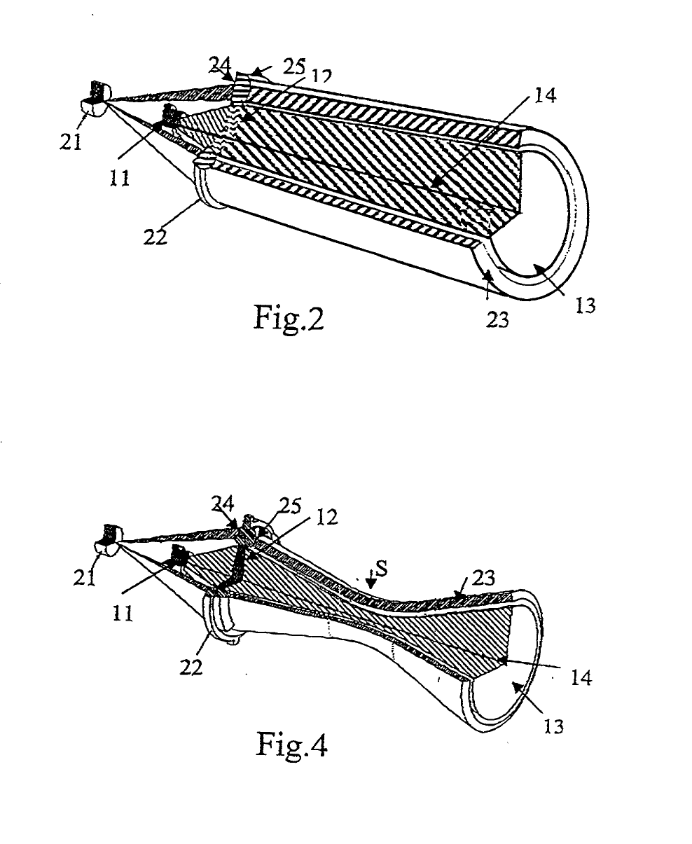

FIG. 2 illustrates the optical system of an IR measurement instrument according to a first type model of the invention in schematic perspective view. With the IR optics 12, the detector 11 is imaged along the optical axis 14 into the infinite, so that the measuring spot becomes bigger and bigger with increasing distance from the IR measuring instrument.

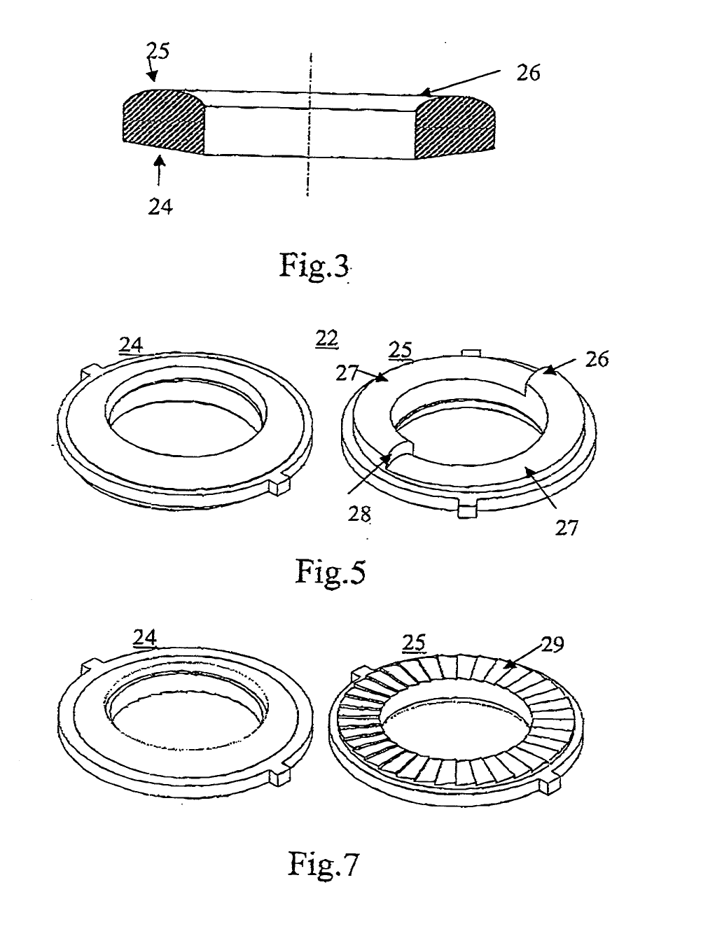

The sighting system 20 comprises the light source 21 and the toroid lens 22, with which the marking beam path 23 is created. The toroid lens 22 is a one-piece ring lens with a first side pointing at the light source 21 (backside 24) and a second side pointing at the object (front side 25). As shown, the backside 24 may be a level or a cone-shaped surface (FIG. 3). The front side 25 is curved in toroid form. The vertical line (26, see FIG. 3), i.e. the line of maximum curvature of front side 25 lies in a reference plane vertical to the optical axis. Marking light that is radiated out from the light source 21 with a design-form-dependent aperture angle hits the backside 24 of the toroid lens 22 and is guided with the latter onto the marking beam path 23 as parallel beam bundle in the shape of a hollow circular cylinder. The inner diameter of the circular cylinder corresponds to the outer diameter of the measuring beam path 11, but it may also be smaller or larger than the latter. The backside is preferably shaped in a cone form. The cone angle is determined in such a way that thus the part of the marking light cone captured by the ring width is deflected in such a manner that after deflection it essentially runs symmetrically to the vertical line of the toroid form front side. This results in the toroid form lens surface introducing smaller imaging errors on the front side that would impair the marking ring quality. At least in a principal section, i.e. a sectional plane, which contains the optical axis, then no extra-axial imaging errors occur.

If the IR optics 12 are shaped in such a way that the measuring spot 51 increases on the object with increasing distance, then the toroid lens is designed so that the marking beam path 23 forms as a diverging beam bundle in the form of a hollow cone.

The toroid lens 22 is made of glass or plastic. The concrete geometric form of the front and backsides 24, 25 is chosen depending on application and is determined using the laws of geometric optics, if necessary using numeric optimization methods. The toroid lens 22 and the IR optics 12 are preferably manufactured in combination, but they may also include separate components.

Typical measurements of the design according to FIG. 2 are, for example:

External diameter of the toroid lens 22 is 34 mm, internal diameter of the toroid lens 22 is 28 mm, distance of light source 21 to toroid lens 22 is 90 mm, distance of detector 11 to toroid lens 22 is 60 mm, aperture angle of the light source 21 is >21°, curvature radius of the front side 25 is 45 mm.

FIG. 3 shows a cross section of the toroid lens used. The object-side front side 25 of the toroid lens has a curved surface with a vertical line 26 (line of maximum curvature in reference to the plane of the ring optics), which has a distance from the inner or outer edge of the ring optics. Through this, at each point along the circumference of the ring optics a lens is formed that is suitable for producing a parallel beam bundle. With such a lens it is possible to create a marking ring that has a constant width at each distance from the IR measuring instrument.

FIG. 4 shows, analogous to FIG. 2, the optical system of an IR measuring instrument according to a modified design form. The IR optics 12 image the detector 11 along the optical axis 14 into the finite, so that the measuring beam path 13 is a one-sheet hyperboloid. Emanating from IR optics 12, the image of the detector 11 shrinks to a sharp point measuring spot S, then the image of the detector is enlarged, as is illustrated with the measuring beam path 13. The distance from the IR optics 12 to the sharp point measuring spot S is exactly 1.15 m for example. Before and after the sharp point measuring spot S, the measuring beam path 13 has a specific divergence that is determined by the IR optics 12.

The toroid lens 22 is designed to direct the light from the light source 21 into the hyperboloid-shaped marking beam path 23, which like the measuring beam path has no focus, but only a tightest restriction (waist), which coincides with the sharp point measuring spot S. The marking beam path 23 is formed through light from the light source 21 being redirected on the toroid lens 22 in straight tracks, which run at an obtuse angle to each other and to the optical axis on a hyperboloid surface, which encompasses the measuring beam path 13. For this purpose, the toroid lens 22 has a non-axially-symmetrical lens body on whose backside 24 a cone surface and on whose front side 25 a partly continuous, helical shaped ring surface is formed.

FIG. 5 shows details of these back and front sides 24, 25 of toroid lens 22 without the IR optic. The backside 24 (left partial picture) has a surface like the outer rim of a conventional collimator lens or a truncated cone shaped surface. The front side 25 (right partial picture) derives from the toroid form according to FIG. 2. The partly continuous, helical ring surface has the shape of an obtuse toroid with an ascending vertical line 26 in one section 27. Between the sections 27 a non-continuousness in the form of a step 28 is provided for. The front side 25, diverging from FIG. 5, may only be one section, or may be divided into more than two sections (e.g. 10 or more).

The cone angle of the backside 24 and the gradient angle of the helical ring surface define the location and the diameter of the waist of the marking beam path 23. Typical measurements of the setup according to FIG. 3 are, for example: outer diameter of the toroid lens 22 is 34 mm, inner diameter of the toroid lens 22 is 28 mm, distance from light source 21 to toroid lens 22 is 90 mm, distance from detector 11 to toroid lens 22 is 60 mm, aperture angle of the light source 21 is >21°, curvature radius of the front side 25 is approx. 45 mm, cone angle of the back side 24 is 21°, gradient angle of the ring surface is approx. 1°.

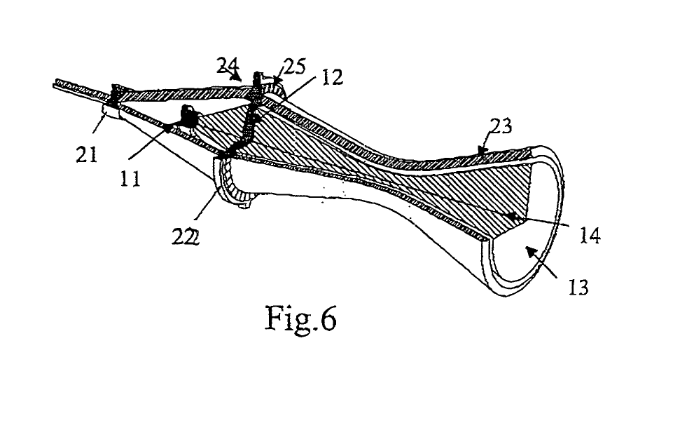

Analogous to FIGS. 4 and 5, FIGS. 6 and 7 show a further type model of the invention with a bevel-edged lens 22, which in turn is designed for the formation of a hyperboloid form marking beam path 23. The front side 25 of the bevel-edged lens 22 comprises a multitude of radially aligned prismatic bevels 29. The prismatic bevels 29 are parts of circular sectors that are twisted around an axis vertical straight line with a small angle amount (bevel angle). The bevel angle defines the diameter of the waist of the marking beam path 23. Typical measurements of the setup according to FIG. 6 are, for example: outer diameter of the bevel-edged lens 22 is 34 mm, inner diameter of the bevel lens 22 is 28 mm, distance from light source 21 to bevel lens 22 is 90 mm, distance from detector 11 to bevel lens 22 is 60 mm, aperture angle of the light source 21 is 21°, cone angle of the backside 24 is 21°, cone angle of the backside 24 is 21°, bevel angle is 1°.

The ring optics 22 (toroid or bevel lens) is illuminated according to one of the following concepts. If a collimated laser beam is created with light source 21, then an optical component part for the change of the laser beam into a radiation field with a cone shaped broadening intensity distribution is provided for. The optical component part is, for example, a cone lens (refractive axicon, see FIG. 6, convex or concave). The expansion of the laser beam depends on the refractive index, the axicon angle and the wavelength of the incident radiation. Alternatively, the optical component part can also be a diffractive axicon, where then the expansion depends on the radial grid period and the wavelength. When a non-collimated radiation source (e.g. laser diode, LED, or fiber end) is provided for, it may be sufficient that the backside of the ring optics 22 is directly illuminated with the expanding radiation field of the light source (see FIGS. 2, 4). If the radiation source is not axially symmetrical, the marking ring created according to the invention can have a corresponding asymmetry in the intensity to compensate.

In the type model examples shown, the ring optic was designed as a ring lens. In the framework of the invention however, it would also be conceivable that the marking light does not penetrate through the ring optics, but is reflected on it. In this case too, the ring optics would have to be designed so that the marking light is directed in such a way that at each location of the marking beam path its vertical cross section to the optical axis forms a circular ring surface.

In FIGS. 8 and 9 two examples of circular ring surfaces are shown. FIG. 8 shows the variant of a closed circular ring, as is created especially in a ring optic 22 according to FIGS. 2 and 7. FIG. 9 shows an interrupted circular ring surface, which could be formed by the ring optic according to FIG. 5, for example. The two interruptions result from the two discontinuities between the sections 27.

The circular ring surface in the sense of the invention can be produced through a closed as well as through an interrupted circular ring surface. In a preferred design variant, the radial width of the circular ring is constant for all distances from the measuring device. In the framework of the design variant according to FIG. 4, it would however also be conceivable that the width of the circular ring becomes a little smaller to the sharp point measuring spot S and then becomes larger again. In this manner, during a measurement in the sharp point measuring spot, the exact distance can be visualized even more clearly.

The described type models of the invention can be modified as follows. Instead of arranging the detector coaxially, it could be placed sideways at a distance from the sighting system and a reflecting mirror is provided for between the detector and the IR optics.

The characteristics of the invention revealed in the above description, the drawings and the claims could be of importance individually as well as in any arbitrary combination for the realization of the invention in its different configurations.

What is claimed is:

1. A device for non-contact temperature measurement on an object, comprising:
a detector device with a detector and IR optics, which image the detector along a measurement beam path with an optical axis on a measuring spot on to the object; and
a sighting system for the visualization of the measuring spot with a light source for the creation of marking light and a ring optic, which forms a marking beam path, which surrounds the outer circumference of the measuring beam path, characterized by the fact that the marking light is aligned so that on each location of the marking beam path its vertical cross section toward the optic axis forms a circular ring surface.

2. The device according to claim 1, in which the ring optic is formed by a toroid lens whose lens body shows at least by sections the form of a toroid surface in such a way that the lens body possesses along the entire circumference an axial cross section surface, which on its front side pointing to the object has the form of a circular section.

3. The device according to claim 1, in which the marking light is aligned so that the circular ring surface on each location of the marking beam path is formed with constant radial width.

4. The device according to claim 2, in which the toroid lens for the creation of a marking beam path is aligned in the form of a one-sheet hyperboloid and has a toroid form surface by sections, whose vertical line on the front side of the lens body lies in at least two partial sections in reference planes each, which form an angle unequal to 90° opposite the optical axis of the detector.

5. The device according to claim 1, in which the ring optic is formed by a bevel lens whose lens body has a multitude of radially aligned prismatic bevels on the front side pointing to the object.

6. The device according to one of the preceding claims 2 through 5, in which the lens body of the ring optics has a truncated cone shaped surface on the backside pointing away from the object.

7. The device according to one of the preceding claims, in which the light source is formed by a laser diode or a light emitting diode or a combination of a laser with a light pipe or fiber or an axicon.

8. The device according to one of the preceding claims in which the detector is positioned between the ring optics and the light source and the IR optics are provided for in the middle of the ring optics.

9. The device according to one of the preceding claims which is designed for manual, hand-held and hand-operated operation.

10. A device for the visualization of the measuring spot of an IR temperature measuring instrument with a sighting system which has a light source and ring optics, with which a marking lighting is aimed from the light source along a marking beam path on an object, where the marking beam path surrounds the outer circumference of the measuring beam path of the IR temperature measuring instrument, characterized by the fact that the marking lighting is directed by the light source with the ring optics so that at each location of the marking beam path, its cross section vertical to the optical axis forms a circular ring surface.
